(19) United States
(12) Patent Application Publication
(10) Pub. No.: US 2015/0304858 A1
(43) Pub. Date: Oct. 22, 2015

(54) Improved demarcation system and method of use

(71) Applicant: Christopher Harold LOWE, (US)

(72) Inventor: Christopher Harold Lowe, Dallas, TX (US)

(21) Appl. No.: 14/435,409

(22) PCT Filed: Oct. 15, 2013
(86) PCT No.: PCT/US13/65147

§ 371 Date: Apr. 13, 2015

Related U.S. Application Data
(60) Provisional application No. 61/712,809, filed on Oct. 12, 2012.

(51) Int. Cl. H04W 16/18; H04W 24/02

(52) U.S. Cl. CPC H04W 16/18; H04W 24/02; H04W 84/12

(57) ABSTRACT

An improved demarcation point system comprising a first improved demarcation point comprising a data input-output system, a power input system, and a processing unit. Said data input-output system comprises a network controller, a femtocell, and a Wi-Fi antenna. Said power input system receives a power supply for said first improved demarcation point. Said first improved demarcation point is installed at a first location. Said data input-output system receives and broadcasts a data signal to and from a first telephony network (also referred to as an upstream data signal) and to and from said first location (also referred to as a downstream data signal). Said processing unit comprises a data storage, a one or more processors, a one or more memory units, and a communication hardware. Said communication hardware communicates signals between said processing unit and both said data input-output system and said power input system.

### BACKGROUND

In telephony, the demarcation point is the point at which the public switched telephone network ends and connects with the customer's on-premises wiring. It is the dividing line which determines who is responsible for installation and maintenance of wiring and equipment—customer/subscriber, or telephone company/provider. The demarcation point varies between countries and has changed over time.

Examples of demarc systems or components replied upon in this application and hereby incorporated by reference can be found at U.S. Pat. Nos. 7,672,448 B2, 8,279,805 B2, and U.S. Pat. No. 8,295,215 B2, as well as patent number CN 100495463 C.

Demarcation point is sometimes abbreviated as demarc, DMARC, or similar. The term MPOE (minimum or main point of entry) is synonymous, with the added implication that it occurs as soon as possible upon entering the customer premises. A network interface device often serves as the demarcation point.

### SUMMARY

An improved demarcation point system and a method of using an improved demarcation point are disclosed.

Said improved demarcation point system comprising a first improved demarcation point comprising a data input-output system, a power input system, and a processing unit. Said data input-output system comprises a network controller, a femtocell, and a Wi-Fi antenna. Said power input system receives a power supply for said first improved demarcation point. Said first improved demarcation point is installed at a first location. Said data input-output system receives and broadcasts a data signal to and from a first telephony network (also referred to as an upstream data signal) and to and from said first location (also referred to as a downstream data signal). Said processing unit comprises a data storage, a one or more processors, a one or more memory units, and a communication hardware. Said communication hardware communicates signals between said processing unit and both said data input-output system and said power input system.

Said method of using an improved demarcation point comprising: attaching a plurality of improved demarcation points to a one or more locations, sending and receiving an upstream data between said plurality of improved demarcation points on a first telephony network, and sending and receiving a downstream data between said plurality of improved demarcation points and their respective one or more locations. Said plurality of improved demarcation points each comprise a data input-output system, a power input system, and a processing unit. Said data input-output system comprises a network controller, a femtocell, and a Wi-Fi antenna. Said power input system receives a power supply for said first improved demarcation point. Said first improved demarcation point is installed at a first location. Said data input-output system receives and broadcasts a data signal to and from a first telephony network (also referred to as said upstream data signal) and to and from said first location (also referred to as said downstream data signal). Said processing unit comprises a data storage, a one or more processors, a one or more memory units, and a communication hardware. Said communication hardware communicates signals between said processing unit and both said data input-output system and said power input system.

### BRIEF DESCRIPTION OF THE DRAWINGS

FIGS. 1A, 1B, 1C and 1D illustrate a perspective overview of an improved demarcation point on a wired telephony network, and three flow diagrams of said improved demarcation point as described below.

FIG. 1B illustrates a schematic diagram of said improved demarcation point with a plurality of locations.

FIG. 1C illustrates a detailed data schematic of said first improved demarcation point at said first location.

1D illustrates a detailed power schematic of said first improved demarcation point 10 at said first location.

FIG. 2 illustrates a schematic view of said improved demarcation point.

FIG. 3 illustrates an elevated overview of an improved wireless data network in a real world setting. In one embodiment, said improved demarcation point can be used to modify a wireless data network into said improved wireless data network.

FIG. 4A illustrates an elevated overview of said improved wireless data network without said improved demarcation point.

FIG. 4B illustrates an elevated overview of said improved wireless data network utilizing said improved demarcation point.

FIG. 5 illustrates an elevated overview of said improved wireless data network utilizing said remote terminal.

FIG. 6 illustrates an elevated schematic view of said remote terminal.

### DETAILED DESCRIPTION

Described herein is an improved demarcation system and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

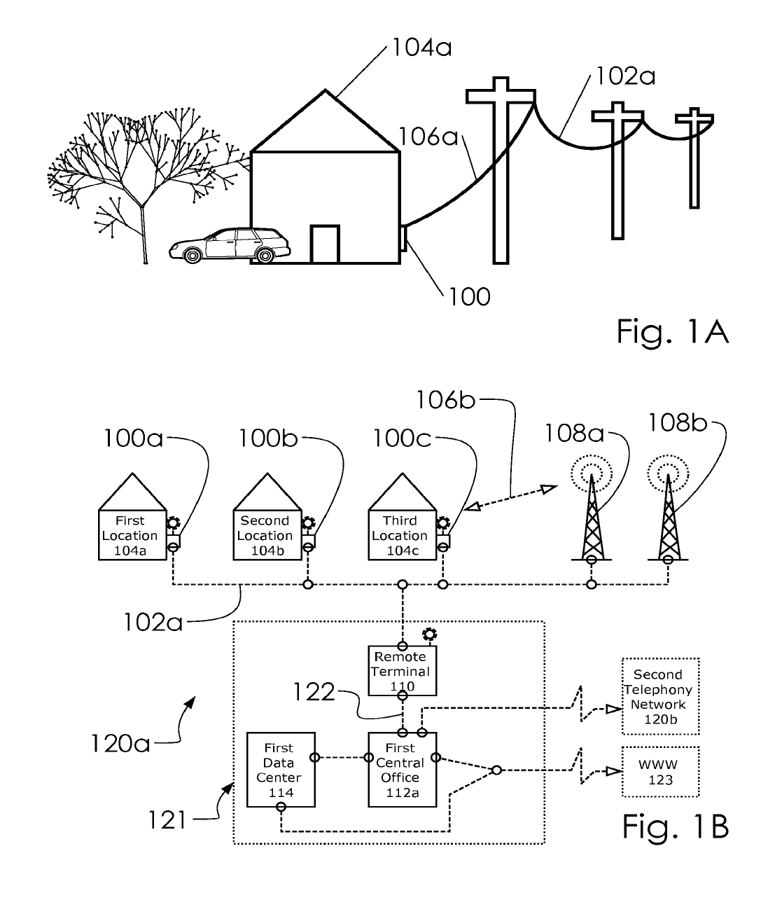

FIGS. 1A, 1B, 1C and 1D illustrate a perspective overview of an improved demarcation point 100 on a wired telephony network 102a, and three flow diagrams of said improved demarcation point 100 as described below. In one embodiment, said improved demarcation point 100 (or “smart demarcation system”) can be installed into one or more locations. In one embodiment, said one or more locations can comprise one or more residences or dwellings. In one embodiment, a first telephony network 120a can comprise said wired telephony network 102a and a wireless telephony network 102b. In one embodiment, said first telephony network 120a can connect to one or more of said one or more locations through a network line 106a or a wireless signal 106b, as is known in the art. In one embodiment, said one or more locations can comprise a first location 104a. In one embodiment, said network line 106a can carry a data signal 202 (discussed and illustrated below) and a power supply 203 (discussed and illustrated below) to said improved demarcation point 100. In one embodiment, said wired telephony network 102a can be connected to said one or more locations through an above ground wired network (as illustrated) or through a below ground network, as is known in the art.

FIG. 1B illustrates a schematic diagram of said improved demarcation point 100 with a plurality of locations. In one embodiment, said one or more locations can comprise said first location 104a, a second location 104b and a third location 104c. In one embodiment, said improved demarcation point 100 can be allocated to a single location (such as said first location 104a) or can be allocated to a plurality of locations (such as said first location 104a, said second location 104b and said third location 104c). In one embodiment, said improved demarcation point 100 can be allocated to a multi-person location, such as an apartment complex, office building, or commercial facility. Thus, said improved demarcation point 100 can be one-to-one, one-to-many and/or many-to-one. In one embodiment, said improved demarcation point 100 can comprise redundant equipment capable of scaling up in a modular fashion to accommodate user needs.

In one embodiment, a plurality of improved demarcation points (that is more than one of said improved demarcation point 100) can be useful together. In one embodiment, said plurality of improved demarcation points can comprise a first improved demarcation point 100a, a second improved demarcation point 100b and a third improved demarcation point 100c. Referring now to FIG. 1B, said first improved demarcation point 100a can attach to said first location 104a, said second improved demarcation point 100b can attach to said second location 104b and said third improved demarcation point 100c can attach to said third location 104c. Each of said plurality of improved demarcation points can be connected together by said wired telephony network 102a and/or said wireless telephony network 102b. Said first telephony network 120a can comprise a range of state of the art and legacy data/VOIP networks as will be discussed below and/or known in the art. Focusing on said wired telephony network 102a, said plurality of improved demarcation points can attach to said wired telephony network 102a along with a one or more transmission towers and a telecom provider network 121. In one embodiment, said one or more transmission towers can comprise a first tower 108a and a second tower 108b. In one embodiment, said one or 30 more transmission towers can comprise a one or more transmission towers operated by different wireless service providers, as is known in the art. For example, in one embodiment, said first tower 108a can be owned and/or operated by Verizon® and said second tower 108b can be owned and/or operated by AT&T®. Nonetheless, each of said one or more transmission towers can be attached to the same telephony network, though this is not required for said improved demarcation point 100 to operated properly. In one embodiment, said telecom provider network 121 can comprise a remote terminal 110, a first central office 112a and a first data center 114. In one embodiment, said first central office 112a can service more than one of said remote terminal 110. In one embodiment, said telecom provider network 121 can connect to a second telephony network 120b (that is another set of said one or more locations with said plurality of improved demarcation points and said one or more transmission towers). In one embodiment, said telecom provider network 121 and said first telephony network 120a can attach to a World Wide Web 123, as is known in the art. In one embodiment, data communicated within said telecom provider network 121 between said remote terminal 110, said first central office 112a and/or said first data center 114 can be transmitted on an internal network 122 and can be encrypted at said remote terminal 110.

In one embodiment, said first telephony network 120a can be designed to stay active in the case that said wired telephony network 102a fails. For example, in one embodiment, if said wired telephony network 102a fails, said plurality of improved demarcation points can each comprise a wireless transmitter (discussed more below) which can communicate with one another, said one or more transmission towers and/or said remote terminal 110 (which can comprise a wireless transmitter). In this way said improved demarcation point 100 is designed to provide a continuous digital communication signal to said plurality of improved demarcation points, or what can be referred to as a “digital heartbeat”. Likewise, because said plurality of improved demarcation points are capable of communicating with one another and said one or more transmission towers, and thus behave like localized towers, said plurality of improved demarcation points can be referred to as a “Tower Area Network”.

FIG. 1C illustrates a detailed data schematic of said first improved demarcation point 100a at said first location 104a. In one embodiment, said improved demarcation point 100 can be useful for relaying data from a mobile device 128. In one embodiment, said mobile device 128 can comprise a mobile phone, a desktop, a laptop, a tablet, a server, or similar; provided that said mobile device 128 comprises a means to communicate with said improved demarcation point 100, such as Wi-Fi or a wired network. In one embodiment, said improved demarcation point 100 can be useful for offloading data from said wireless telephony network 102b where said mobile device 128 is in data communication with said improved demarcation point 100 (or said first improved demarcation point 100a, as illustrated here). For example, in one embodiment, said mobile device 128 can pass VOIP data over said improved demarcation point 100 (and said wired telephony network 102a) when appropriate bandwidth is available. Accordingly, said plurality of improved demarcation points can protect valuable spectrum or data bandwidth by removing local traffic to the local network. However, in one case, where said wired telephony network 102a is overwhelmed, high priority data (such as VOIP) can be rerouted to said wireless telephony network 102b either through said improved demarcation point 100 or bypassing said improved demarcation point 100, as illustrated.

In one embodiment, said plurality of improved demarcation points can be useful for enabling other types of data communications from said one or more locations. For example, in one embodiment, said first improved demarcation point 100a can connect to a one or more utility meters 130, a one or more smart devices 132, a security or automation system 134, or similar. In one embodiment, said one or more utility meters 130 can comprise a water meter, an electric meter, a gas meter, or similar. In one embodiment, said one or more smart devices can comprise appliances with sensors and network communications ports, such as smart-refrigerators, smart-washers, and similar. In one embodiment, said security or automation system 134 can comprise home security systems, video surveillance systems, automated locks, climate control systems, irrigation systems, and similar. It is known in the art within the United States, that some electricity meters comprise data broadcast capabilities. However, many times data broadcast from said one or more utility meters 130 can be done in harmful spectrum and intensities (such as microwave data broadcasting). In one embodiment, said improved demarcation point 100 can be configured to send and receive all data broadcasts to and from said one or more utility meters 130. This configuration would save spectrum by consolidating data from said one or more utility meters 130 to said wired telephony network 102a, it may eliminate the need for microwave data communication, and would eliminate the need for data privacy issues for the utilities since their data would be handled on a privacy assured network such as said first telephony network 120a. Likewise, the movement of data across said wired telephony network 102a to said one or more locations can facilitate the sell and marketing of well-known media services such as cable TV, internet, phone service, mobility (such as mobile phones), and the like. Such services can gain access from devices at said one or more locations to data on said first data center 114 or on a super data hub 115 (which can connect to more than one of said first data center 114). Likewise, a third-party data which has been collected at said plurality of improved demarcation points can be stored at said first data center 114 and/or said super data hub 115; wherein, said third-party data can be useful for billing customers of said one or more utility meters 130 or for serving said media services (discussed above). In one embodiment, said improved demarcation point 100 can comprise short range tag readers such as RFID readers (discussed below), wherein said third-party data can comprise data about RFID tags within said one or more locations, which can serve to create an inventory of items at said one or more locations. Accordingly, the automatic management of local inventories can allow for easy cataloging, selling and/or taxation of items sold from said one or more locations. In one embodiment, said third-party data can be accessed by a third party with approved credentials. For example, in one embodiment, a utility provider would have approved credentials to access third-party data related to said one or more utility meters 130.

One feature of said plurality of improved demarcation points at said one or more locations 10 can comprise the ability to provide telephony services to manufacturers and marketers of said one or more smart devices 132 and/or said security or automation system 134 and thereby bypass the need to sell telephony services to the owners of said one or more locations. For example, in one embodiment, said one or more smart devices 132 can contract with the operator of said first telephony network 120a for access to all of his devices when in range of said improved demarcation point 100 on said first telephony network 120a, regardless of a subscription status between said operator of said first telephony network 120a and owners of said one or more locations.

Another feature of said plurality of improved demarcation points on said first telephony network 120a is localized access to said first data center 114 which can comprise libraries of data such as large media file used in video web services such as Youtube.com and/or Netflix.com.

FIG. 1D illustrates a detailed power schematic of said first improved demarcation point 100a at said first location 104a. In one embodiment, said plurality of improved demarcation points can be helpful in providing power to locations among said one or more locations. For example, in one embodiment, said plurality of improved demarcation points can receive a power input from said wired telephony network 102a in any of many known the forms of power transmission, for example, power over fiber (a new technology in the art, hereby incorporated by reference), power of copper, coax power transmission, or similar. Likewise, said plurality of improved demarcation points can be configured to receive said power input from wireless transmission of power (a new technology in the art, hereby incorporated by reference) such as technology introduced by “XBEE®”. In one embodiment, said first improved demarcation point 100a (as illustrated here) can be receiving a power input from said wired telephony network 102a, a power grid 140 (as is known in the art), an on premises power source (such as a solar panel 142), or similar. In one embodiment, said power grid 140 is helpful to provide a jumper power source to said first improved demarcation point 100a. In one embodiment, said wired telephony network 102a can have a battery backup 144 at said first central office 112a. In one embodiment, said battery backup 144 can comprise four 12V batteries per telephony line on said first telephony network 120a, as is common in some systems. In one embodiment, said improved demarcation point 100 can comprise a battery 224 (discussed below) to function as another backup power source for said first telephony network 120a.

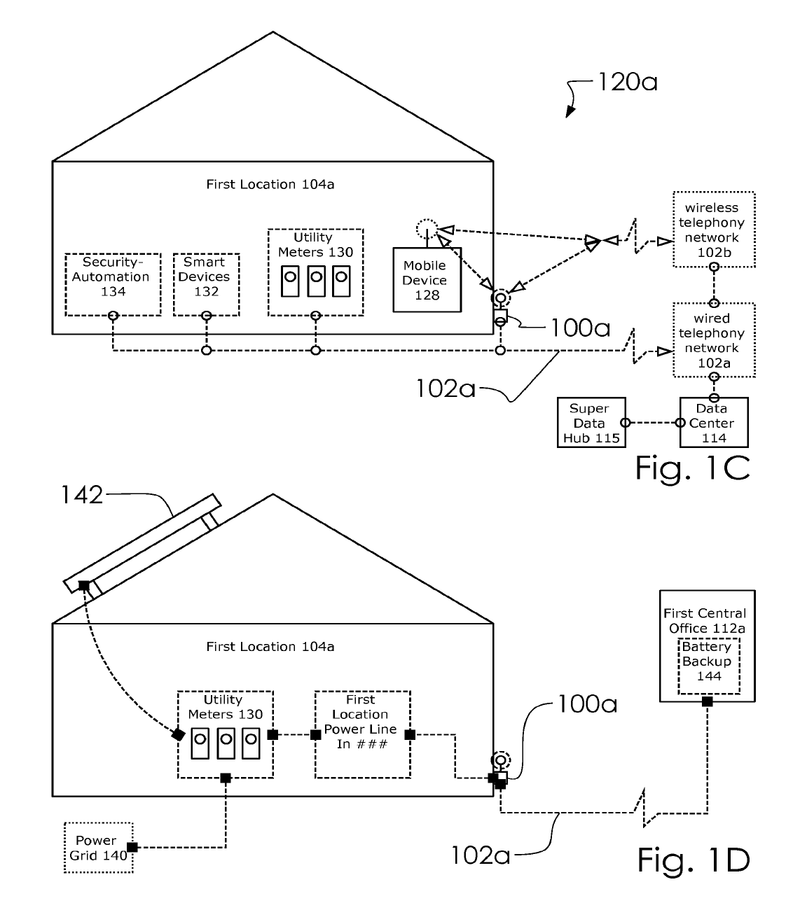

FIG. 2 illustrates a schematic view of said improved demarcation point 100. In the United States, the modern demarcation point is a device defined by FCC rules (47 C.F.R. Part 68) to allow safe connection of third-party telephone Customer-premises equipment and wiring (such as a location network 201) to the Public Switched Telephone Network (PSTN) (such as said wired telephony network 102a). In one embodiment, said location network 201 can comprise a network of wires in said one or more locations attached to one or more telephones. The modern demarcation point (prior art) can comprise the network interface device (NID); wherein, the NID is the telco's property. The NID may be outdoors (typically, mounted on the building exterior in a weatherproof box) or indoors. The NID is usually placed for easy access by a technician. In one embodiment, the NID can be modified and/or replaced by said improved demarcation point 100.

In one embodiment, said improved demarcation point 100 can receive said data signal 202 and said power supply 203. In one embodiment, said improved demarcation point 100 can comprise a one or more internal components 205, a power input system 218, a data input-output system 220 and a processing unit 211. In one embodiment, said power input system 218 can receive said power supply 203 through said telephony network, said power grid 140, or by a variation on these as described above. In one embodiment, said data input-output system 220 can receive said data signal 202 from an upstream data signal (that is outside of said one or more locations), handle said data signal 202 in said data input-output system 220, pass said data signal 202 a downstream data signal (that is inside of said one or more locations), and do the same operation in reverse. In most cases, everything from the central office to said improved demarcation point 100 (said upstream data signal) are owned by the carrier and everything past it is owned by the property owner (said downstream data signal). In one embodiment, said power supply 203 can comprise a lighting arrestor 204, a one or more fuses 206, and a test circuit 208. In one embodiment, said power input system 218 can comprise a power unit 212, an RJ-11 jack 214, and said battery 224. In one embodiment, said power input system 218 can receive said power supply 203 from outside of said improved demarcation point 100 and put said power supply 203 to work within said improved demarcation point 100. In one embodiment, said data input-output system 220 can comprise a network controller 210, a one or more data antennas 216, a femtocell 217, a RFID reader 222, and a Wi Fi antenna 213. In one embodiment, said processing unit 211 can comprise a portal 226 and a data storage 228. In one embodiment, parts of said improved demarcation point 100 can be modular and therefore subject to easy repair, replacement and upgrading.

In one embodiment, said one or more internal components 205 (including said lighting arrestor 204, said one or more fuses 206 and/or test circuit 208) can allow the carrier to remotely test whether a wiring fault lies in the customer premises or in the carrier wiring, without requiring a technician at the premises. In one embodiment, said RJ-11 jack 214 (a “test jack” or a “demarcation jack”) of said improved demarcation point 100 can be connected directly to said wired telephony network 102a, and a small loop of telephone cord connecting to the jack by a modular connector. When the loop is disconnected, said location network 201 can be isolated from said wired telephony network 102a and the customer may directly connect a telephone to the network via a jack to assist in determining the location of a wiring fault.

In one embodiment, said power input system 218 can power said improved demarcation point 100. In one embodiment, said RJ-11 jack 214 can carry a power supply (such as said power supply 203) to said one or more locations. Likewise, RJ-11 jack ports at said one or more locations can be converted into USB power outlets with an adapter such that said first telephony network 120a can be used to power devices through said RJ-11 jack 214.

In one embodiment, said processing unit 211 can process said data signal 202, communicate with said carrier's network (such as said wired telephony network 102a), communicate with other improved demarcation points, facilitate use of said one or more data antennas 216 and said femtocell 217, distribute a VOIP and/or data signal on said location network 201, and similar. In one embodiment, said processing unit 211 can comprise a one or more processors 230 capable of data computations, a one or more memory units 232 capable of read one and random access storage of data, and a communication hardware 234 capable of communicating with other components and machines.

In one embodiment, said data input-output system 220 can handle communications upstream and downstream from said improved demarcation point 100. In one embodiment, said one or more data antennas 216 can communicate with a carrier through a central office or other well-known node. In one embodiment, said carrier can deliver VOIP, digital television, digital radio, video conferencing, internet, intranet, and/or similar signals across said wired telephony network 102a and/or through said one or more data antennas 216. In one embodiment, said one or more data antennas 216, said femtocell 217 data input-output system 220 can operate as an upstream data handlers capable of connecting to said first telephony network 120a and said network controller 210 can operate as a downstream data handlers with data from said improved demarcation point 100 and into said one or more locations. In one embodiment, said network controller 210 can communicate through said location network 201 through a wired connection or through said Wi-Fi antenna 213 (or an equivalent, or similar network). In one embodiment, said upstream data handlers, being numerous with multiple avenues to said telecom provider network 121 and/or said World Wide Web 123, is robust due to its redundancies. Accordingly, said improved demarcation point 100 can provide a reliable means of communication and a ready “digital heart-beat” as discussed above. In one embodiment, said data signal 202 can comprise a signal from a neighbor (that is another among said one or more locations), one of said one or more transmission towers, and/or said wired telephony network 102a (copper, fiber, or similar).

In one embodiment, said network line 106a can carry said data signal 202 to said data input-output system 220 and said power supply 203 to said power input system 218. In one embodiment, said power supply 203 can be sent to said power unit 212 through said data input-output system 220. In one embodiment, said data signal 202 can be sent to said network controller 210 through said power input system 218. In one embodiment, said data signal 202 and said power supply 203 can be delivered to said improved demarcation point 100 through a single wire, such as said network line 106a. In one embodiment, said data signal 202 can be delivered to said data input-output system 220 through a smart grid, a DSL network, a coax cable network, a fiber network, a twisted pair network, or similar. In one embodiment, said improved demarcation point 100 will not comprise said power input system 218; wherein, said improved demarcation point 100 can comprise a passive demarcation point.

In one embodiment, said network line 106a can comprise a fiber optic cable, a coaxial cable, or sometimes an unshielded twisted pair of wires. In one embodiment, said improved demarcation point 100 can comprise the equipment necessary to interface with said location network 201 (or the original premises POTS wiring and equipment) to the new communication channel.

In many places several customers share one central DEMARC (such as said improved demarcation point 100) for a commercial or strip mall setting. Usually a DEMARC will be located indoors if it is serving more than a single customer. This may impede access. Outdoor DEMARC systems may provide easier access, that is access without disturbing other tenants, but may call for weatherproofing and/or punching through a wall for each new addition of wires and service. Typically indoor DEMARC's can be easily identified by a patch panel of telephone wires on the wall next to a series of boxes with RJ-45 jacks for T-1 lines.

In one embodiment, said one or more data antennas 216 of said improved demarcation point 100 can comprise a wireless data transmission point. In one embodiment, said one or more data antennas 216 can be capable of broadcasting a one or more wireless data signals to a one or more wireless nodes and/or wireless devices. For example, in one embodiment, said one or more data antennas 216 can broadcast said one or more wireless data signals to said mobile device 128. In one embodiment, said one or more data antennas 216 can communicate on current (known) transmission standards or be reprogrammed/replaced to accommodate future protocols.

In one embodiment, said femtocell 217 can comprise a cellular and/or wireless data base station. In one embodiment, said femtocell 217 can be used as is known in the art. In one embodiment, said femtocell 217 can be referred to as a “microcell”. In one embodiment, said femtocell 217 can have limitations similar to those of known in the art currently (typically having a range of 200 m to 2 km). In one embodiment, said femtocell 217 can have an increased range as the need for greater ranges and signal strength/types are called for. In one embodiment, said femtocell 217 can connect to a plurality of carrier networks to accommodate communications between said mobile device 128 and said carrier networks. In one embodiment, said plurality of improved demarcation points can be selectively assigned to individual carriers so as to cut down on network congestion; wherein, said femtocell 217 of said first improved demarcation point 100a can be assigned to a first carrier, said femtocell 217 of said second improved demarcation point 100b can be assigned to a second carrier, and so forth. However, each of said femtocell 217 can be assigned to more than one carrier as necessary to balance network traffic on said first telephony network 120a.

In one embodiment, said improved demarcation point 100 can comprise modular 10 additions capable of adding new functionality to said improved demarcation point 100 and therefore extend new services to one or more of said one or more locations. For example, in one embodiment, one of said modular additions can comprise a module capable of controlling home automation tasks such as climate control, home security, video services such as cable and video on demand; and internet service provision. In one embodiment, an owner of said improved demarcation point 100 can collect a fee to allow a vender access to said improved demarcation point 100 and/or said wired telephony network 102a.

In one embodiment, said RFID reader 222 can be used to read short range tags such as RFID tags for cataloging and inventory features, as discussed above. In one embodiment, said battery 224 can be used to ensure said plurality of improved demarcation points remain connected to said first telephony network 120a. In one embodiment, said portal 226 can comprise a set of software programs hosted in said improved demarcation point 100 allowing an owner or maintenance personnel of said one or more locations or said first telephony network 120a to connect to said improved demarcation point 100 remotely and set administrative settings relevant to said improved demarcation point 100 with a user interface device (such as a tablet, PC, or smart phone). In one embodiment, said data storage 228 can store data created or collected at said improved demarcation point 100, which can comprise said third party data as discussed above.

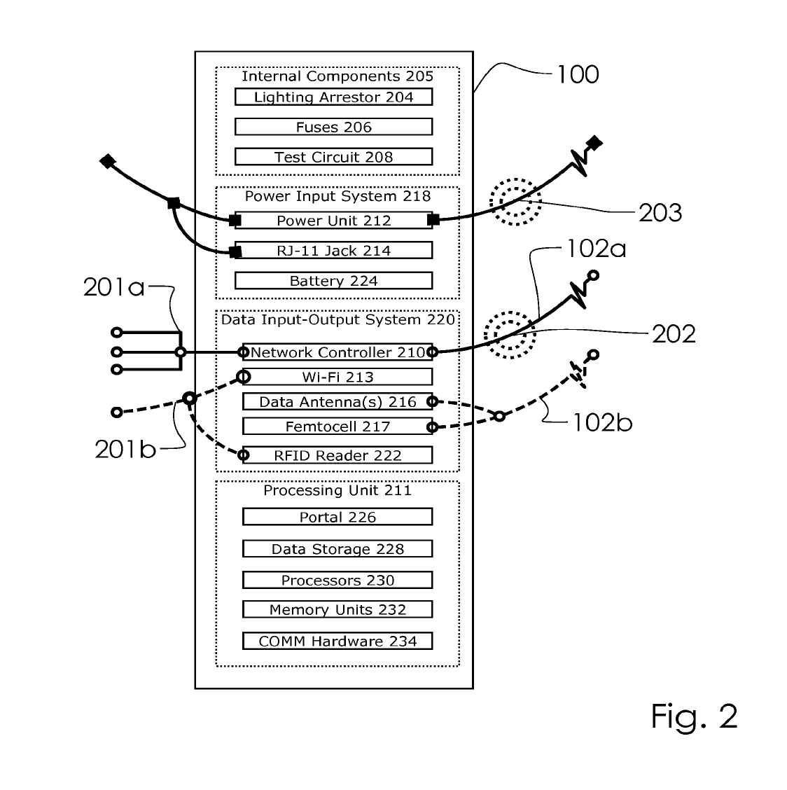

FIG. 3 illustrates an elevated overview of an improved wireless data network 300 in a real world setting. In one embodiment, said improved demarcation point 100 can be used to modify a wireless data network into said improved wireless data network 300. As are well known in the art, said wireless data network comprises a one or more transmission towers connected to one another and one or more other networks (such as said World Wide Web 123) by a wired network (such as said wired telephony network 102a); wherein, said one or more transmission towers are capable of broadcasting said one or more wireless data signals from said one or more transmission towers. Unfortunately, despite extensive infrastructure spending on deploying a vast set of said one or more transmission towers, said carriers are not able to reach and cover all useful locations for customers. Likewise, since the real estate is a finite resource, some carriers are unable to purchase access to enough locations so as to roll out said one or more transmission towers as they may desire. Accordingly, there is a great need for said improved wireless data network 300 in order to help solve this problem.

In one embodiment, said improved demarcation point 100 can be included in said improved wireless data network 300 in order to increase network coverage for said carriers. In one embodiment, said one or more wireless data signals can comprise a first signal 302a from said first tower 108a, and a second signal 302b from said first improved demarcation point 100a. In one embodiment, said first signal 302a can be blocked by an obstacle, such as a hill 304, and thereby be prevented from reaching a user location 306. Accordingly, it is feasible that said first improved demarcation point 100a can have an easier broadcast path for said second signal 302b than does said first tower 108a for said first signal 302a due to said obstacle. Likewise, where said one or more transmission towers cannot be built, regardless of the reason, said improved demarcation point 100 can be used as an alternative network access point. Further, since said improved demarcation point 100 may be cheaper to build and deploy since said carriers have an easement to install said improved demarcation point 100 in said one or more locations. Thus, in one embodiment said improved wireless data network 300 can be improved by the inclusion of said improved demarcation point 100 (or, more precisely, said plurality of improved demarcation points). Other examples of obstacles (such as said hill 304) comprise buildings, mountains, canyons, valleys, trees, forest, precipitation, or similar.

Using said improved demarcation point 100 can comprise installing said improved demarcation point 100 into a plurality of said one or more locations and/or said dwellings, and modifying said wireless data network into said improved wireless data network 300.

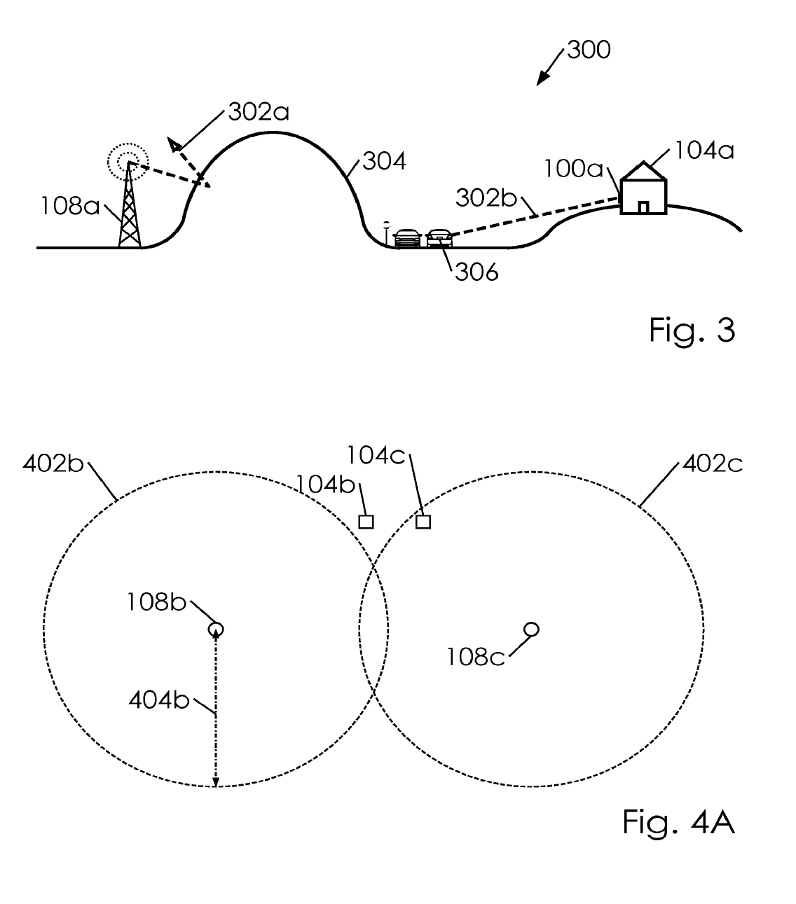

FIG. 4A illustrates an elevated overview of said improved wireless data network 300 without said improved demarcation point 100. In one embodiment, said improved wireless data network 300 can comprise one or more of said one or more transmission towers. In one embodiment, said one or more transmission towers can comprise a second tower 108b and a third tower 108c. In one embodiment, said second tower 108b can comprise a transmission range 404b and said third tower 108c can comprise a transmission range 404c. In one embodiment, said transmission range 404b and said transmission range 404c can be substantially circular. In one embodiment, said transmission range 404b about said second tower 108b can comprise a second cell 402b. In one embodiment, said transmission range 404c about said third tower 108c can comprise a third cell 402c. In one embodiment, said improved wireless data network 300 can comprise a plurality of tower cells such as said second cell 402b and said third cell 402c. In one embodiment, said plurality of tower cells can comprise coverage for a portion of said one or more locations. In one embodiment, said one or more locations can comprise a second location 104b and a third location 104c. Thus, as illustrated, said plurality of tower cells can provide coverage to said third location 104c but not said second location 104b.

FIG. 4B illustrates an elevated overview of said improved wireless data network 300 utilizing said improved demarcation point 100. In one embodiment, said one or more locations can comprise said improved demarcation point 100; wherein, said improved wireless data network 300 can be improved by adding a plurality of demarcation cells to said improved wireless data network 300. For example, in one embodiment, said plurality of demarcation cells can comprise a second demarcation cell 408b about said second location 104b and a third demarcation cell 408c about said third location 104c.

In one embodiment, having said improved demarcation point 100 in a plurality of said one or more locations can ensure data and VOIP coverage within difficult to cover locations.

In one embodiment, using said improved demarcation point 100 to improve said improved wireless data network 300 can lead to power savings as wireless traffic will not need to be broadcast as far for a majority of calls.

Likewise, incorporating said improved demarcation point 100 into said one or more locations 104 can prove to be a redundant and useful measure during a national or regional emergency as several of said one or more transmission towers may have been destroyed during an act of God (e.g., tornadoes, hurricanes, etc.) or an act of man. In one embodiment, said improved wireless data network 300 can be used to off-load network traffic from said one or more transmission towers; thereby, said one or more transmission towers are free to carry critical traffic in locations under duress.

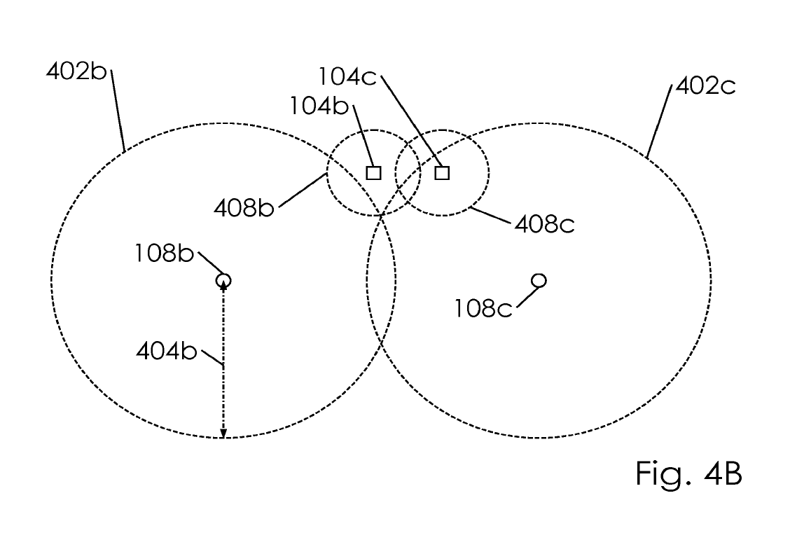

FIG. 5 illustrates an elevated overview of said improved wireless data network 300 utilizing said remote terminal 110. In one embodiment, one or more of said improved demarcation point 100 can connect to said remote terminal 110 over said wired telephony network 102a. In one embodiment, said remote terminal 110 can maintain and/or conduct a data communication with said one or more of said improved demarcation point 100 on said wired telephony network 102a. In one embodiment, said remote terminal 110 can connect to said one or more locations each comprising one or more of said improved demarcation point 100.

In one embodiment, said remote terminal 110 can distribute data from said wired telephony network 102a to one or more of said one or more transmission towers. For example, in one embodiment, said third demarcation cell 408c can receive a data signal 502 where said third cell 402c for said third tower 108c cannot handle said data signal 502. Thereafter, said data signal 502 can be communicated from said improved demarcation point 100 at said third location 104c through said wired telephony network 102a to said remote terminal 110 and to a more optimal location such as a less congested portion of said wired telephony network 102a among said one or more transmission towers. For example, in one embodiment, where said third tower 108c with said third cell 402c are too congested, said data signal 502 can be received at said improved demarcation point 100 at said third location 104c, then communicated to said remote terminal 110 within said second cell 402b, and said data signal 502 can be sent to said second tower 108b rather than the more congested third tower 108c.

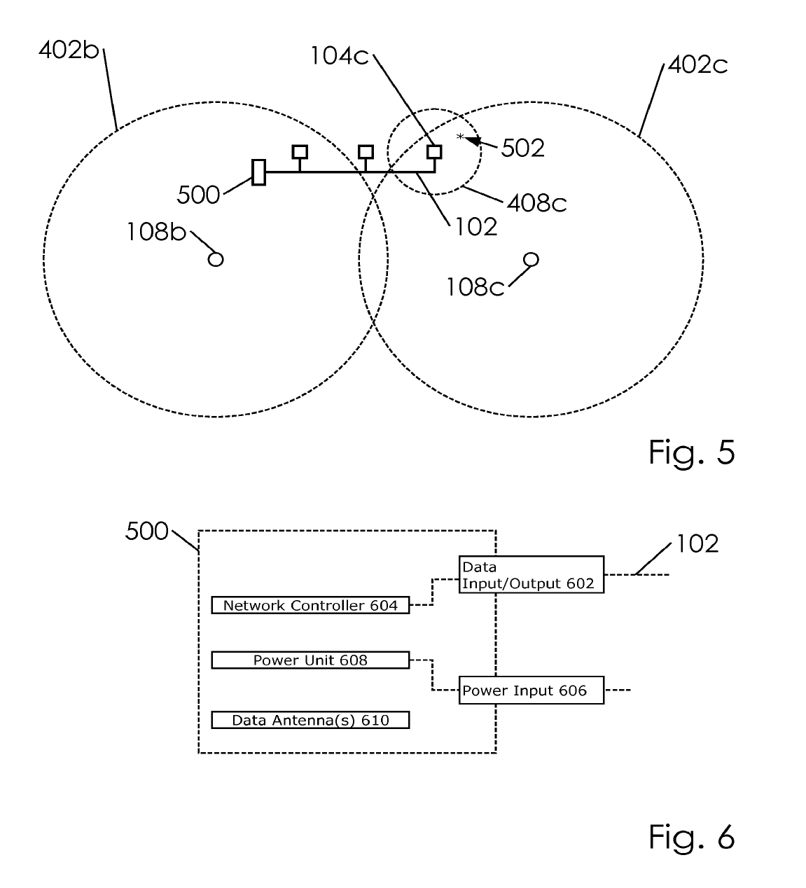

FIG. 6 illustrates an elevated schematic view of said remote terminal 110. In one embodiment, said remote terminal 110 can communicate with said wired telephony network 102a by connecting a portion of said wired telephony network 102a to a data input-output 602. In one embodiment, said remote terminal 110 can comprise said data input-output 602, a network controller 604, a power input 606, a power unit 608, and one or more data antenna 610. In one embodiment, said remote terminal 110 can receive a power source through said power input 606 and distribute said power source to operate said remote terminal 110 with said power unit 608. In one embodiment, said remote terminal 110 can distribute said data signal 502 to one or more of said one or more transmission towers by broadcasting said data signal 502 through said one or more data antenna 610.

In one embodiment, data carried across said wired telephony network 102a can be handled in a “data agnostic” manner. That is, in one embodiment, said improved demarcation point 100 can transmit, receive and broadcast data at one of said one or more locations without regard to the source of that data (as between provider 1 vs. provider 2, etc.).

In one embodiment, one or more of said remote terminal 110 can be used to optimize data deliver to said one or more transmission towers. For example, in one embodiment, said data signal 502 could be delivered to a plurality of said remote terminal 110 before reaching a transmission point capable of finding a data ready tower among said one or more transmission towers.

In one embodiment, said improved demarcation system and method of use can be useful for offloading data from said wired telephony network 102a and getting the most important portion among said data signal 502 to a portion of said one or more transmission towers capable of receiving the same. A particularly apt example would be offloading said wired telephony network 102a during an emergency evacuation (such as masses fleeing from an incoming hurricane). Another example can comprise offloading traffic in a congested area such as a sporting 40 venue or business district. Another example can comprise receiving data in locations where said plurality of tower cells are week or do not properly overlap without use of said improved demarcation point 100.

On the other hand, it may not be advantageous for data signal 502 to be “long hauled” too far from an original broadcast location. Such long hauling may cause data fidelity loss, and could possibly cause a cellular call to become a VOIP call and therefore be subjected to whatever regulatory and technological limitations may exist for VOIP calls in a given jurisdiction.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1.-27. (canceled)

28. An improved demarcation point comprising:
a data input-output system comprising:
a wired network interface;
a first wireless network interface; and
a second wireless network interface; and
a processing unit comprising:
a processor configured to:
evaluate upstream transmission conditions of at least two of: the wired network interface; the first wireless network interface; and the second wireless network interface; and
select one of: the wired network interface; the first wireless network interface; or the second wireless network interface for transmission of an upstream communication based upon the upstream conditions.

29. The improved demarcation point of claim 28, wherein the first wireless network interface comprises a connection with a cellular base station, and the processor selects the first wireless network interface for transmission when a wired network connected to the wired network interface is overwhelmed with traffic.

30. The improved demarcation point of claim 28, wherein the first wireless network interface comprises a connection with a cellular base station, the upstream communication is from a cellular mobile device, and the processor selects the wired network connection for transmission when a wired network connected to the wired network connection has available transmission bandwidth.

31. The improved demarcation point of claim 28, wherein the first wireless network interface comprises a connection with a cellular base station, and the processor selects the first wireless network interface for transmission when the a wired network connected to wired network interface fails or is unavailable.

32. The improved demarcation point of claim 28, wherein the second wireless network interface comprises a connection with a second improved demarcation point, and the processor selects the second wireless network interface for transmission when a wired network connected to the wired network interface fails or is unavailable.

33. The improved demarcation point of claim 28 further comprising:
a power input system comprising:
a primary power supply; and
a backup power source;

34. The improved demarcation point of claim 33, wherein the primary power supply receives power from a first source external to a premises where the improved demarcation point is installed, and wherein the backup power source receives power from a second source local to the premises where the improved demarcation point is installed.

35. The improved demarcation point of claim 28, wherein the processor is further configured to receive a communication from a utility meter and transmit the communication to a data hub configured to aggregate a plurality of utility communications and transmit the aggregate to a utility provider.

36. The improved demarcation point of claim 28, wherein the processor is further configured to select an additional one or more of: the wired network interface; the first wireless network interface; or the second wireless network interface for transmission of the upstream communication based upon characteristics of the upstream communication and the upstream conditions.

37. An improved demarcation system comprising:
a first improved demarcation point comprising:
a first data input-output system comprising:
a first wired network interface;
a first wireless network interface; and
a second wireless network interface; and
a first processing unit comprising:
a processor configured to:
determine a wired network connected to the first wired network interface has failed or is unavailable; and
transmit an upstream transmission to a second improved demarcation point;
the second improved demarcation point comprising:
a second data input-output system comprising:
a second wired network interface;
a third wireless network interface; and
a fourth wireless network interface; and
a second processing unit comprising:
a second processor configured to:
receive the upstream transmission at the third wireless network interface;
transmit the upstream transmission via the second wired network interface if a wired network connected to the second wired network is available; and
transmit the upstream transmission via the third wireless network interface to a third improved demarcation point if the wired network connected to the second wired network is not available.

38. The system of claim 37, wherein the first wireless network interface comprises a connection with a first cellular base station associated with a first wireless provider, the third wireless network interface comprises a connection with a second cellular base station associated with a second wireless provider, the first processor is further configured to aggregate a first plurality of communications from a first plurality of mobile devices associated with the first wireless provider and transmit the aggregated first plurality of communications via the first wireless network interface, and the second processor is further configured to aggregate a second plurality of communications from a second plurality of mobile devices associated with the second wireless provider and transmit the aggregated second plurality of communications via the third wireless network interface.

39. A method implemented in an improved demarcation point, the method comprising:
evaluating, by a processor, upstream transmission conditions of at least two of: a wired network interface; a first wireless network interface; and a second wireless network interface; and
selecting, by the processor, one of: the wired network interface; the first wireless network interface; or the second wireless network interface for transmission of an upstream communication based upon upstream conditions.

40. The method of claim 39, wherein the first wireless network interface comprises a connection with a cellular base station, and the processor selects the first wireless network interface for transmission when a wired network connected to the wired network interface is overwhelmed with traffic.

41. The method of claim 39, wherein the first wireless network interface comprises a connection with a cellular base station, the upstream communication is from a cellular mobile device, and the processor selects the wired network connection for transmission when a wired network connected to the wired network connection has available transmission bandwidth.

42. The method of claim 39, wherein the first wireless network interface comprises a connection with a cellular base station, and the processor selects the first wireless network interface for transmission when a wired network connected to the wired network interface fails or is unavailable.

43. The method of claim 39, wherein the second wireless network interface comprises a connection with a second improved demarcation point, and the processor selects the second wireless network interface for transmission when a wired network connected to the wired network interface fails or is unavailable.

44. The method of claim 39 further comprising:
receiving power via a power input system comprising:
a primary power supply; and
a backup power source;

45. The method of claim 44, wherein the primary power supply receives power from a first source external to a premises where the improved demarcation point is installed, and wherein the backup power source receives power from a second source local to the premises where the improved demarcation point is installed.

46. The method of claim 39 further comprising:
receiving, by the processor, a communication from a utility meter; and
transmitting the communication to a data hub configured to aggregate a plurality of utility communications and transmit the aggregate to a utility provider.

47. The method of claim 39 further comprising selecting an additional one or more of: the wired network interface; the first wireless network interface; or the second wireless network interface for transmission of the upstream communication based upon characteristics of the upstream communication and the upstream conditions.

48. An improved demarcation method comprising:
determining a wired network connected to a wired network interface of a first improved demarcation point has failed or is unavailable;
wirelessly transmitting an upstream transmission from the first improved demarcation point to a second improved demarcation point;
receiving the upstream transmission at a wireless network interface of the second improved demarcation point;
transmitting the upstream transmission via the a wired network interface of the second improved demarcation point if the wired network connected to the wired network interface of the second improved demarcation point is available; and
wirelessly transmitting the upstream transmission to a third improved demarcation point if a wired network connected to the wired network interface of the second improved demarcation point is not available.

49. The method of claim 48 further comprising
associating a first wireless interface of the first improved demarcation point with a first wireless provider;
associating a second wireless interface of the second improved demarcation point with a second wireless provider;
aggregating, by the first improved demarcation point, a first plurality of communications from a first plurality of mobile devices associated with the first wireless provider;
transmitting, by the first improved demarcation point, the aggregated first plurality of communications;
aggregating, by the second improved demarcation point, a second plurality of communications from a second plurality of mobile devices associated with the second wireless provider; and
transmitting, by the second improved demarcation point, the aggregated second plurality of communications.
